(19) United States
(12) Patent Application Publication
(10) Pub. No.: US 2018/0012144 A1
(43) Pub. Date: Jan. 11, 2018

(54) INCREMENTAL AND SPECULATIVE ANALYSIS OF JAVASCRIPTS BASED ON A MULTI-INSTANCE MODEL FOR WEB SECURITY

(71) Applicant: Qualcomm Innovation Center, Inc., San Diego, CA (US)

(72) Inventors: Wei Ding, San Diego, CA (US); Dineel Sule, San Diego, CA (US); Subrato Kumar De, San Diego, CA (US); Sajo Sunder George, San Diego, CA (US); Zaheer Ahmad, San Diego, CA (US)

(21) Appl. No.: 15/442,989

(22) Filed: Feb. 27, 2017

Related U.S. Application Data
(60) Provisional application No. 62/360,680, filed on Jul. 11, 2016.
(60) Provisional application No. 62/376,833, filed on Aug. 18, 2016.

(51) Int. Cl. G06N 99/00; H04L 29/06

(52) U.S. Cl. CPC G06N 99/005; H04L 63/1416

(57) ABSTRACT

Web security methods and apparatus are disclosed herein. A method includes receiving a detection model for detecting malicious webpages via a transceiver of the computing device, and storing the detection model in a non-volatile memory of the computing device. One or more JavaScripts are detected in the webpage, wherein each of the JavaScripts can be separately executed. A feature vector for each of the JavaScripts may be generated, either incrementally as the web page is being loaded or prefetching the JavaScript for the web page, to produce one or more feature vectors for the webpage, wherein a particular feature vector includes values for different features of a JavaScript. Each of the feature vectors are analyzed with the multi-instance learning based detection model to determine whether the webpage from which the JavaScripts originate is malicious or benign.

### CLAIM OF PRIORITY UNDER 35 U.S.C. §119

The present Application for Patent claims priority to Provisional Application No. 62/360,680 filed Jul. 11, 2016 and Provisional Application No. 62/376,833 filed Aug. 18, 2016, both entitled “Enhancing Web Security through effective use of Multi-Instance Machine Learning Based Models for Real Time Detection of Malicious JavaScript during Web Browsing” and assigned to the assignee hereof and hereby expressly incorporated by reference herein.

### BACKGROUND

### Field

The present embodiments relate generally to Web security, and more specifically to detection of malicious JavaScripts.

### Background

JavaScript is the programming language of the World Wide Web (“WWW”) or the Internet. It is used in nearly all websites, and in many applications like maps, docs, emails, social networking, and online games. The Web being the largest attack surface on any device today, JavaScript based attacks remain one of the top threats for cybersecurity. With the continuous shift of Internet users from desktops to mobile devices, JavaScript attacks are also becoming a major threat on mobile devices.

Most malicious JavaScript attacks utilize the characteristics of the JavaScript language and the constraints of the Web specifications for the exploits. Some examples of attack types include:
Cross-Site Scripting, i.e., XSS/CSS: Reflected and Stored XSS;
Cross Site Request Forgery i.e., CSRF/XSRF;
Drive by Downloads;
User Intent Hijacking: Clickjacking, like jacking;
Distributed Denial of Service (DDoS);
JavaScript Steganography: malicious JavaScripts in images found in Webpages (Internet is full of images); and
Obfuscated JavaScript hiding various malicious intents.
   Most JavaScript exploits have no visible indication on the platform activity (e.g., there are no system calls invoked in most JavaScript attacks), which is different from ANDROID-operating-system malware that results in visible indications on a device's application programming interfaces and system calls.

Most JavaScript based attacks are outward facing and compromise the user's online assets, activity, and identity. Visible activity patterns are only seen within the Web browser/application software. Although almost all web browsers use signature detection, pattern detection, or use blacklisting services, these existing web browsers are not able to effectively detect 0-day attacks or effectively mitigate against the harm of previously unseen attacks and exploits when the signatures or patterns of the previously unseen attacks/exploits is different from known attacks and exploits.

### SUMMARY

An aspect includes a method for detecting malicious webpages stored in a non-volatile memory of a computing device. The method includes detecting multiple JavaScripts in a webpage received at the computing device, wherein each of the JavaScripts can be separately executed. A feature vector is generated for each of the JavaScripts to produce a plurality of feature vectors for the webpage, wherein a particular feature vector includes values for different features of a particular JavaScript. Each of the feature vectors is analyzed with a detection model stored on the computing device to determine whether the webpage from which the JavaScripts originate is malicious or benign, the detection model is a multi-instance-based detection model for analyzing multiple JavaScript instances of a webpage-level-bag.

Another aspect includes an apparatus for analyzing and displaying web content. The apparatus includes one or more transceivers for transmitting requests for web content and receiving the web content; a model manager configured maintain a detection model in a non-volatile memory of the computing device; and a webpage processing portion configured to generate requests for the web content, receive the web content, and detect multiple JavaScripts in a webpage, wherein each of the JavaScripts can be separately executed. The apparatus also includes a malicious webpage detector that includes an incremental analysis module configured to incrementally request JavaScripts to render the webpage and analyze the incrementally requested JavaScripts to generate feature vectors as the JavaScripts are incrementally requested; a speculative analysis module configured to prefetch JavaScripts, before the JavaScripts are needed to render the webpage, to generate feature vectors; and a detection module to apply the detection model to the feature vectors to determine whether or not the webpage is malicious.

### BRIEF DESCRIPTION OF THE DRAWINGS

FIG. 1 is a block diagram depicting aspects of a web security system embodied in an offline model generator and a computing device;

FIG. 2 is a diagram depicting aspects of a multi-instance machine learning based approach to generating a detection model for malware detection;

FIG. 3 is a block diagram depicting components of an exemplary offline model generator;

FIG. 4 is a diagram depicting aspects associated with generating feature vectors from JavaScripts in webpages;

FIG. 5 depicts exemplary training input to an offline model generator, an example of a model generated from the exemplary training input, and results of an application of the detection model to exemplary inputs;

FIG. 6 is a block diagram illustrating components of a JavaScript analysis system based on a multi-instance model of a web-page for Web Security as implemented on an exemplary computing device;

FIG. 7 is a flowchart depicting a method that may be carried out in connection with embodiments described herein;

FIG. 8 is a diagram depicting aspects of operations associated with the speculative analysis module depicted in FIG. 6;

FIG. 9 is a diagram depicting aspects of operations associated with the incremental analysis module depicted in FIG. 6;

FIG. 10 is a table depicting features of JavaScripts that may be used to create the detection models described herein; and

FIG. 11 is a block diagram depicting exemplary components of a computing device.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

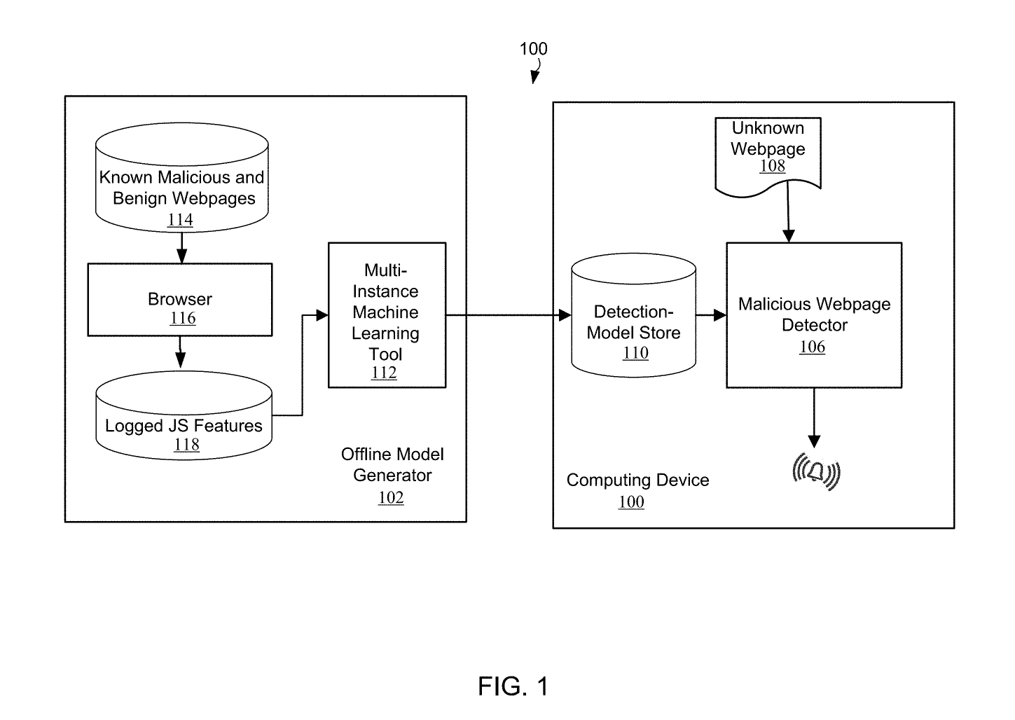

Referring first to FIG. 1, shown is a block diagram depicting a computing device 100 and an offline model generator 102. The computing device 100 may be realized by a variety of devices such as smartphones, netbooks, gaming devices, PDAs, tablets, and laptop computers. The offline model generator 102 may be realized by a server that is connected to the computing device 100 by a network connection that may include the Internet and any of a variety of wireline and wireless networks.

According to several aspects, the computing device 100 includes a malicious webpage detector 106 that effectuates methodologies that are capable of blocking malicious JavaScript code that is experienced when browsing to unknown webpages such as unknown webpage 108. In many instances, the malicious webpage detector 106 may block an entire sequence of events for a web exploit to entirely prevent an attack. The malicious webpage detector 106 may be integrated within a web browser or may be implemented as a separate construct that may operate in connection with a web browser, or web applications installed in the computing device 100.

Another aspect of the malicious webpage detector 106 is a mechanism that can handle 0-day attacks by utilizing a detection model stored on the computing device 100 within a detection model store 110 that provides enhanced protection relative to existing mechanisms in browsers such as pattern and signature based mechanisms and blacklisting-based approaches.

Although it is contemplated that the detection model may be generated in a variety of different ways, in the implementation depicted in FIG. 1, the detection model is generated by a multi-instance machine learning tool 112 implemented by the offline model generator 102. As shown, the offline model generator 102 includes a data store of known malicious and benign webpages 114, a browser 116, and a data store of logged JavaScript features 118.

In general, the offline model generator 102 operates to generate the detection model offline (e.g., separate from the computing device 100) through training of a large set of benign and malicious websites to avoid power and computing overhead. New detection models generated offline through ongoing training may be loaded to the computing device 100 via over the air updates. Some implementations may prefer to do automatic updates of the stored detection model on the computing device 100 through on-device training using the actual webpage 108 encountered during the operation of the web browser or the web applications on the computing device 100.

In the implementation depicted in FIG. 1, the browser 116 is configured to generate a log of JavaScript features that are stored in a data store of logged JavaScript features 118, and the multi-instance machine learning tool 112 generates the detection model using the logged JavaScript features.

In some implementations, the multi-instance machine learning tool 112 uses a “bag of instances” as a training sample, and the bag may be identified malicious if one or more instances in the bag are bad. During training, it may be known that a bag is bad, but it may not be known which instance or instances within the bag are bad. The instances may be JavaScripts, which (as used herein) includes JavaScript files, inline JavaScript code, and dynamically generated JavaScripts. The resultant output of the multi-instance machine learning tool 112 a multi-instance-based detection model for analyzing multiple JavaScript instances of a webpage-level-bag.

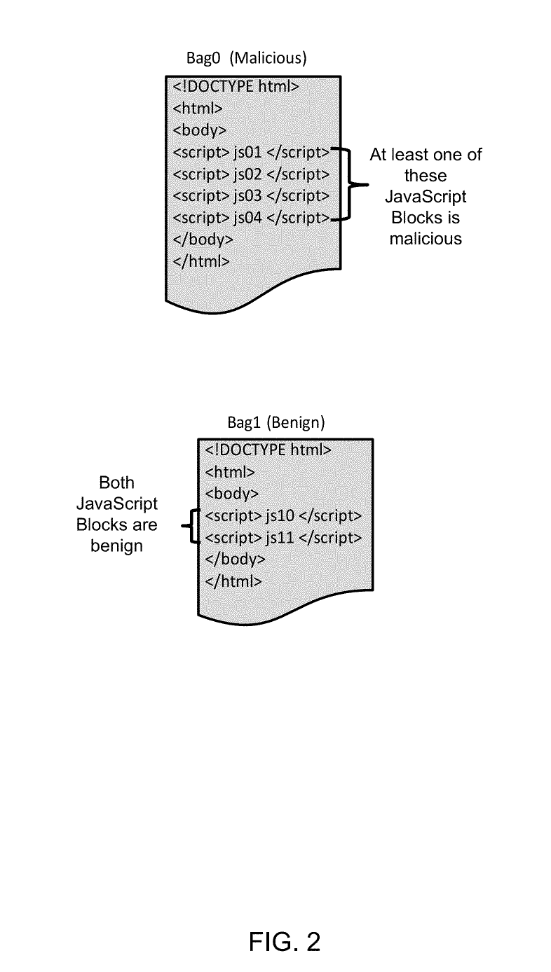

Referring briefly to FIG. 2, shown is a representation of constituents of a webpage as a “bag.” As shown, each bag may have a class label that is either 1 (for a malicious bag) or 0 (for a benign bag). A bag may be labeled benign if all the instances in this bag are benign, and a bag may be labeled as malicious if there is at least one instance in this bag that is malicious. Each instance within the bag may be described by a vector of features, but the label of each individual instance within a bag is unknown.

In the implementation depicted in FIG. 1, the browser 116 is configured to generate the vector of features for each instance, and store the generated vector in the data store of logged JavaScript features 118. In general, the multi-instance machine learning tool 112 generates a detection model that predicts the label (e.g., malicious or benign) of an unknown bag correctly (e.g., a majority of the time).

### Multi-Instance Learning (MIL) vs Single Instance Learning

Some aspects that multi-instance learning and single instance learning have in common are: each instance may be represented by a feature vector; training instances are first used to generate a machine learning model; and then the generated detection model is used to predict the labels (e.g., malicious or benign) of new instances.

Single instance learning (standard supervised learning) is one of the most commonly used machine learning approaches, and every training instance is explicitly labeled (e.g., 1/0, malicious/benign). In contrast, with a multi-instance learning approach, the label information of every instance is unknown, and instead, instances are grouped into bags so the only the label of each bag is known.

In some implementations, a single instance learning model may be undesirable for predicting whether a JavaScript code is malicious or benign because it may be impractical (by virtue of a lack of training sets) because it is hard (if not impossible) to get a large training dataset of malicious JavaScripts directly. In contrast, datasets of malicious/benign webpages (at a bag level) are practically available. As a consequence, a problem of using malicious/benign webpages for training comes to: a malicious webpage can contain both malicious JavaScript code/files and benign JavaScript code/files, and it is not known which JavaScript code/files in a malicious webpage are malicious. The multi-instance machine learning approach is designed to resolve such a problem.

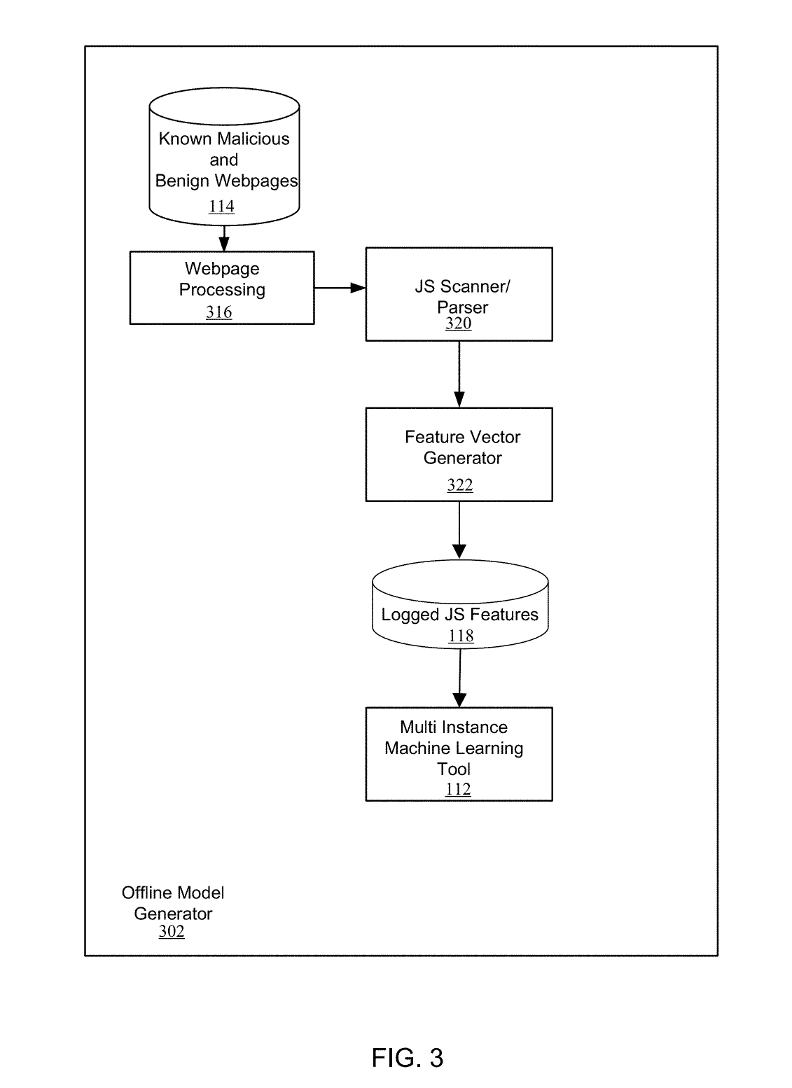

Referring next to FIG. 3, shown is an exemplary offline model generator 302 in which portions of the browser 116 (shown in FIG. 1) are implemented by a web page processing portion 316, a JavaScript scanner/parser 320, and a feature vector (FV) generator 322. The webpage processing portion 316 generically depicts portions of a browser engine and rendering engine that initiates the loading of a webpage, high-level browsing actions, HTML parsing, layout etc.

The JavaScript scanner/parser 320 operates to scan JavaScript instances to tokenize the JavaScripts and parse the JavaScripts to generate an abstract syntax tree (AST) and a symbol table. The feature vector generator 322 operates to generate feature vectors, wherein each feature vector includes values for different features obtained from the tokens (created during the tokenizing process); nodes and edges of the abstract syntax tree, and from the symbol table. This approach (of analyzing the JavaScript just before it is executed) defeats JavaScript obfuscation, which was originally intended to protect intellectual property in code, but is increasingly exploited by attackers to prevent feature extraction and identification of the malicious functionality.

The JavaScript feature vectors generated by the feature vector generator 322 (from the decoded or un-obfuscated JavaScript code) are stored in the data store of logged JavaScript features 118. As discussed above, the multi-instance machine learning tool 112 then generates the detection model for subsequent use as described further herein.

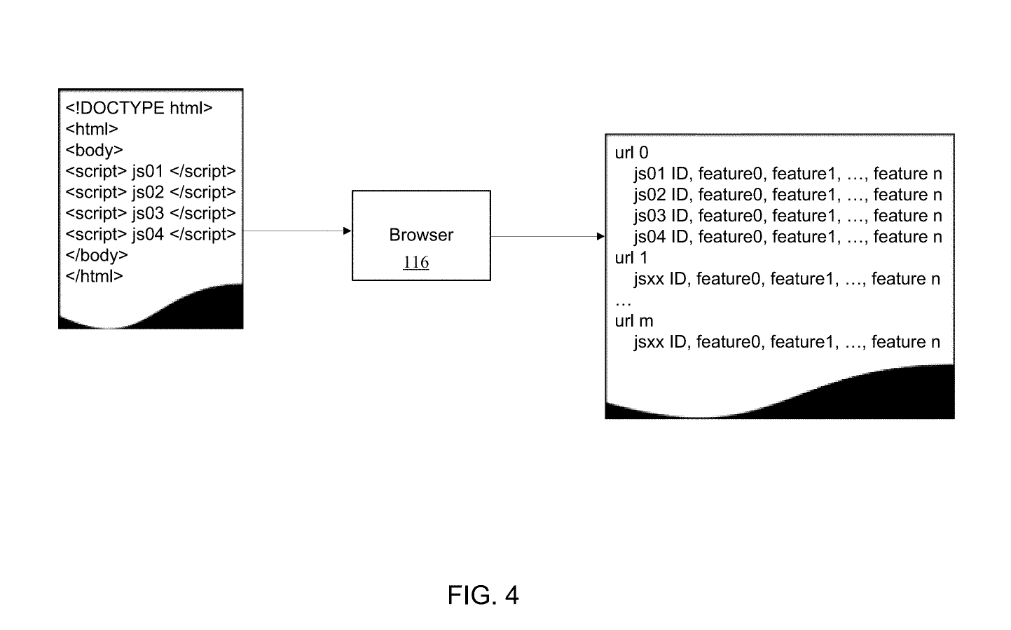

Referring to FIG. 4, shown are an exemplary known webpage and corresponding feature vectors that may be generated (from JavaScripts in the webpage) by the browser 116. In the implementation depicted in FIG. 4, the functionality of the web page processing portion 316, the JavaScript scanner/parser 320, and a feature vector generator 322 is implemented within the browser 116.

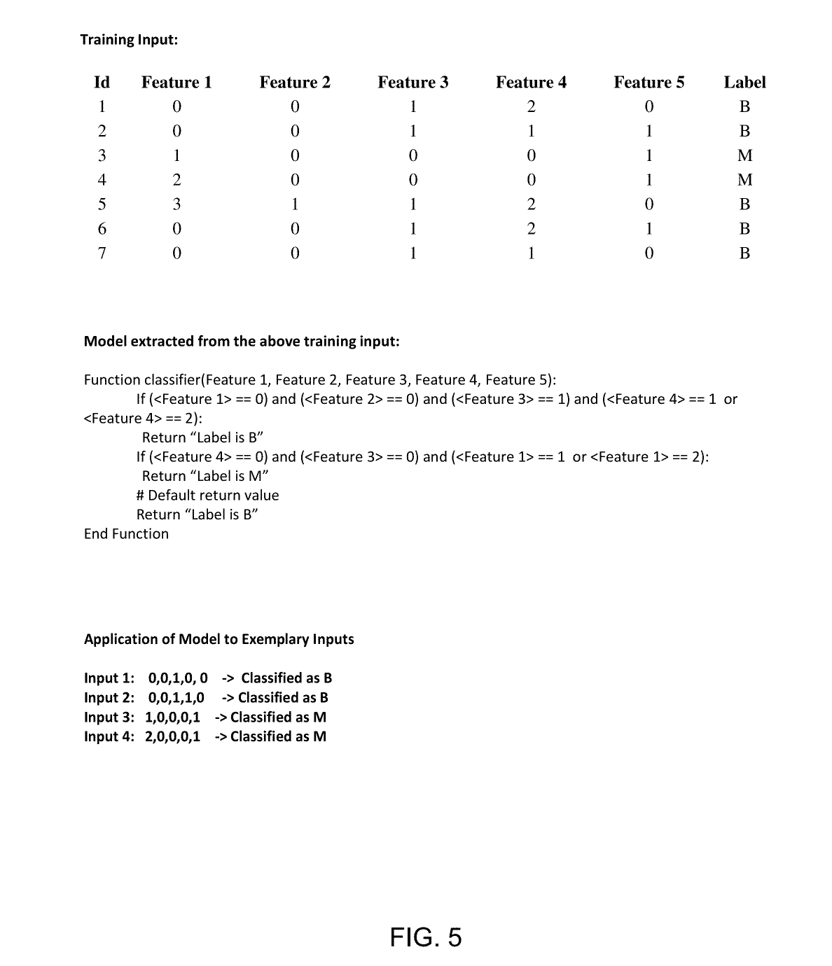

Referring to FIG. 5, shown are seven feature vectors (depicted as the seven rows of the training input) that each have a corresponding identifier (ID) for the corresponding JavaScript. As shown, each of the feature vectors includes feature values for different features. Also shown is an exemplary multi-instance-based detection model that may be generated from the feature vectors of the training input. The exemplary detection model includes logic to create a label (e.g., B for benign JavaScript instances and M for malicious JavaScript instances). Also shown in FIG. 5 is an application of the exemplary detection model to a plurality of inputs. For example, Inputs 1 and 2 represent feature vectors for two unknown JavaScripts that are both classified by the exemplary model as benign, and Inputs 3 and 4 represent feature vectors for two known JavaScripts that are classified as malicious. Although, the multi-instance-based detection model depicted in FIG. 5 can be used to provide a label based upon a single input, the multi-instance-based detection model enables many implementations disclosed herein to provide a label to a webpage-level-bag based upon multiple inputs (e.g., multiple feature vectors generated from corresponding JavaScripts).

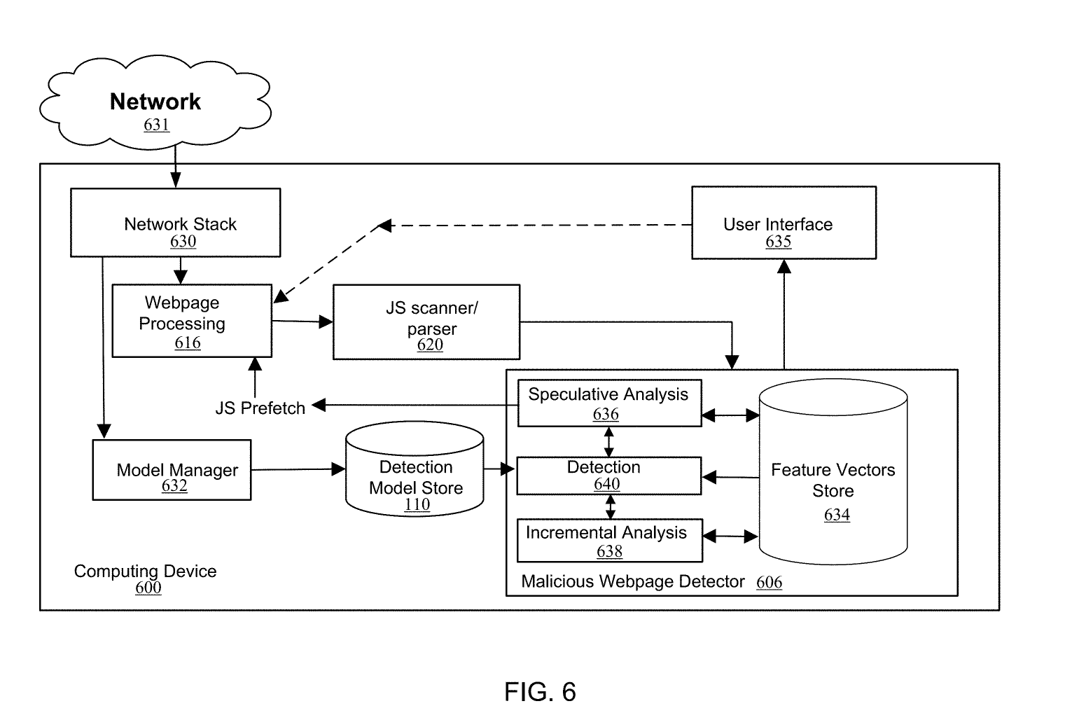

Referring next to FIG. 6, shown is an exemplary computing device 600 that may be used to realize the computing device 100 depicted in FIG. 1. The computing device 600 in this embodiment includes a network stack 630 that is configured to couple a network 631 to components of the computing device 600 such as a webpage processing portion 616 and a model manager 632. The network stack 630 represents a collection of components (e.g., hardware and software) known to those of ordinary skill in the art that enable the computing device 600 to communicate to the network 631, which may include the Internet and a collection of wireless and wireline networks. In addition, the network stack 630 may provide functionality to handle and retrieve content from webpages using Internet protocols such as HTTP and FTP.

The webpage processing portion 616 generally represents portions of a browser engine and rendering engine that initiate the loading of a webpage, high-level browsing actions, HTML parsing, layout etc. Although not required, the webpage processing portion 616 of the computing device 600 may include substantially the same functional components as the webpage processing portion 316 of the offline model generator 302.

The model manager 632 operates to receive and store the detection model in the detection model store 110. The detection model may be received and updated by an over the air update via the network 631 as the offline model generator 102 produces and releases updated detection models. It may also be possible that with optional capability of on-device training and model generation results in automatically updating the model in the computing device 600 at runtime. The model manager 632 also handles auto-update of the models due to on-device training and model generation. The JavaScript scanner/parser 620 is configured to scan the JavaScripts in a received webpage to produce tokens for each JavaScript, and parse the JavaScripts to produce an abstract sytax tree and a symbol table for each of the JavaScripts.

The computing device 600 also includes a malicious webpage detector 606, which is an exemplary implementation of the malicious webpage detector 106 described with reference to FIG. 1. As shown, the malicious webpage detector 606 includes a speculative analysis module 636, an incremental analysis module 638, and a detection module 640. The malicious webpage detector 606 may be integrated within a web browser or may be separately installed from an existing web browser on the computing device 600. Also shown is a user interface 635 that enables a user to interact with browser features of the webpage processing portion 616. This includes the address bar, back/forward button, bookmarking menu, etc. The user interface 635 may also display alarms generated by the malicious webpage detector 606 when a webpage is determined to be malicious. The user interface 635 may need to wait for user inputs when the webpage processing portion 616 needs action from the user after the malicious webpage detector 606 reports a malicious activity.

The speculative analysis module 636 is configured to prefetch JavaScript resources of a webpage, before the JavaScripts are needed to render the webpage, to generate feature vectors corresponding to the JavaScripts. In contrast, the incremental analysis module 638 is configured to incrementally request JavaScript resources as needed to render the webpage and analyze the incrementally requested JavaScripts to generate feature vectors as the JavaScript resources are incrementally needed. And the detection module 640 is configured to apply the detection model to the feature vectors to determine whether or not the webpage is malicious. For example, the detection module 640 may make the determination as to whether or not the webpage is malicious based upon a number of malicious JavaScripts that are detected in the webpage relative to a number of benign JavaScripts in the webpage.

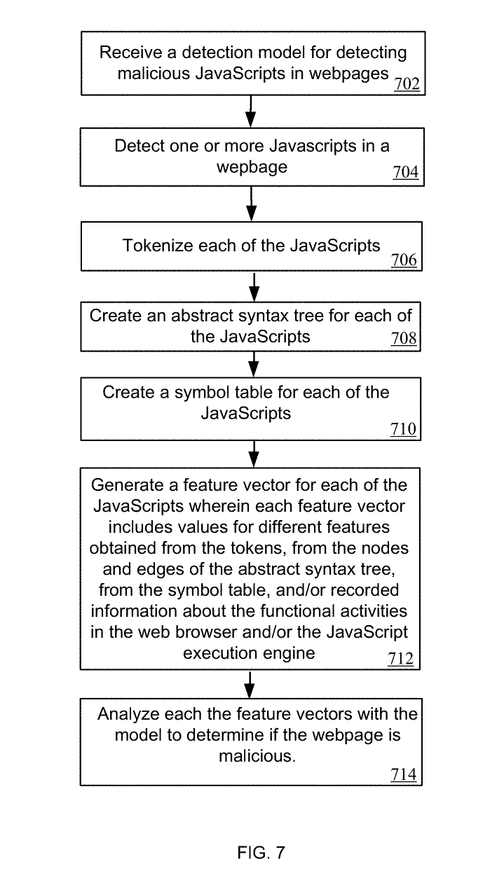

While referring to FIG. 6, simultaneous reference is made to FIG. 7, which is a flowchart depicting aspects of a method for processing web content that may be traversed by the computing device 600. It should be recognized that the flowchart is not intended to detail all the various potential different implementations and modes of operation. Instead, the flowchart captures common aspects of the various different implementations and modes of operation that are discussed further herein.

As shown, a detection model for detecting malicious JavaScripts in web pages is received (Block 702), e.g., via a transceiver of the network stack 630, and the detection model is stored in the detection model store 110 (which may be realized by non-volatile memory) of the computing device 600. An implementation choice of the detection model is a multi-instance learning based detection model that may be generated by the offline model generator 102, 302.

In operation, one or more JavaScripts are detected in a webpage, wherein each of the JavaScript instances can be separately executed (Block 704). Each of the JavaScripts may be tokenized (Block 706), and an abstract syntax tree (AST) may be created for each of the JavaScripts (Block 708). In addition, a symbol table may be created for each of the JavaScripts (Block 710).

A feature vector is generated for each of the JavaScripts, wherein a particular feature vector includes values for different features obtained from the tokens, the nodes and the edges of the abstract syntax tree, and from the symbol table (Block 712). The feature vector may also include other features like information recorded about the functional activities in the web browser and/or the JavaScript execution engine. Examples of such features that are functional activities in the web browser and/or JavaScript engine include reading a cookie, sending a cookie, sending an XHR request, and receiving an HTTP response. As discussed above, the JavaScript resources of the webpage, may be prefetched (by the speculative analysis module 636) before the JavaScript resources are needed to render the webpage in order to generate feature vectors independently from the incrementally requested JavaScript resources (requested by the incremental analysis module 638).

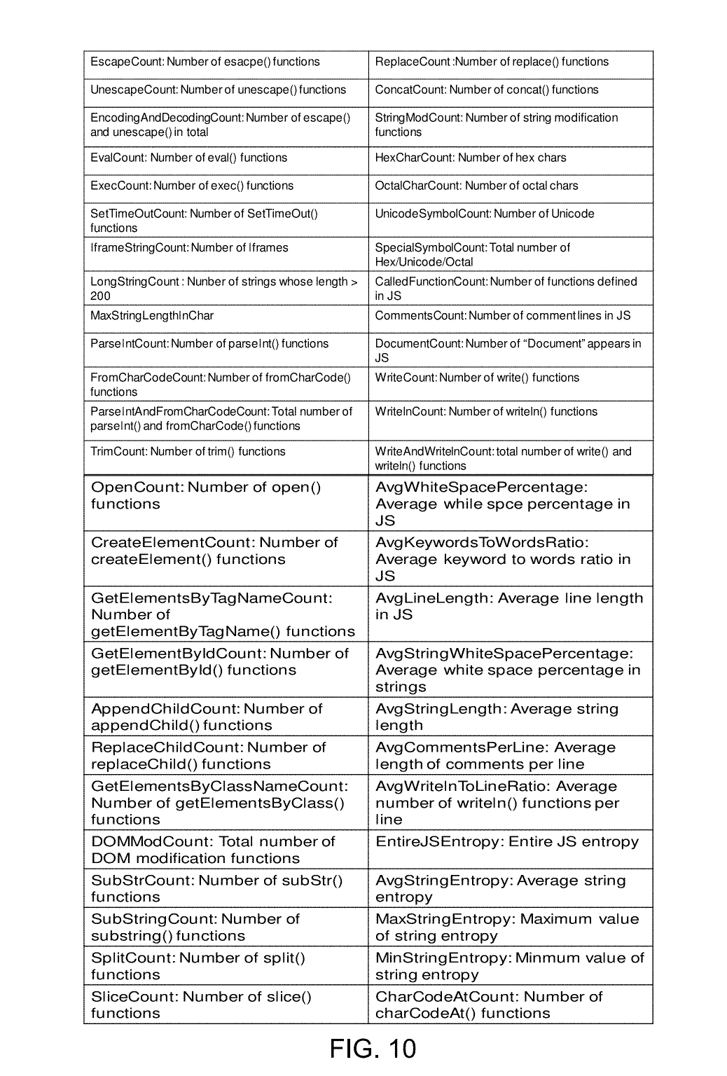

The features may be counts of specific functions. As an example, parseInt( ), may be a node in the AST. So, when there is a node in the AST which is a function and the name of the function is “parseInt( ),” the count for the feature “Total number of parseInt( )” is incremented. Similarly, keywords may be counted as they appear as nodes in the AST. For things like string length, these strings will appear as an input/output variable to/from an AST node, i.e., there will be an association to an edge of the AST. Referring briefly to FIG. 10, shown are exemplary features that may be used to form feature vectors.

It should be noted that a scanner portion of the JavaScript scanner/parser 620 (that is invoked before the parser) tokenizes JavaScript code and keeps it in a temporary data structure before the parser is invoked to create the AST. Features can be obtained when the scanner is tokenizing JavaScript code. For example, the scanner can detect keywords versus variable names In some implementations, a symbol table is created together with the AST where the symbol table can contain the variables (e.g., variable names) and the associated values (e.g., string content, constant values, etc.). So, features can also be obtained from the symbol table is used by the JavaScript scanner/parser 620.

As shown in FIG. 7, each of the feature vectors is analyzed with the detection model to determine whether the webpage from which the JavaScripts originate is malicious or benign (Block 714). One specific implementation (for determining the malicious/benign nature of the webpage being loaded) identifies each of the multiple JavaScript instances as malicious or benign, and the number of malicious JavaScripts in the webpage relative to the number of benign JavaScripts in the webpage is used to make a determination as to whether the webpage is malicious or benign. For example, if the number of malicious JavaScripts is a simple majority of the total number of JavaScripts, the webpage may be determined to be malicious, or if a single instance is found to be malicious the entire web page is considered malicious

The unique combination of the speculative analysis (of the speculative analysis module 636) and the incremental analysis (of the incremental analysis module 638) provides two different levels of granularity for the detection module 640 to provide real-time and yet full coverage.

In operation, the speculative analysis module 636 may launch a speculative parser thread (also referred to herein as Thread A) that runs in parallel (or in the background), so the main page loading is not blocked, and Thread A gathers all received JavaScript code from the webpage for speculative JavaScript parsing (or pre-parsing) to extract features for the feature vector store 634.

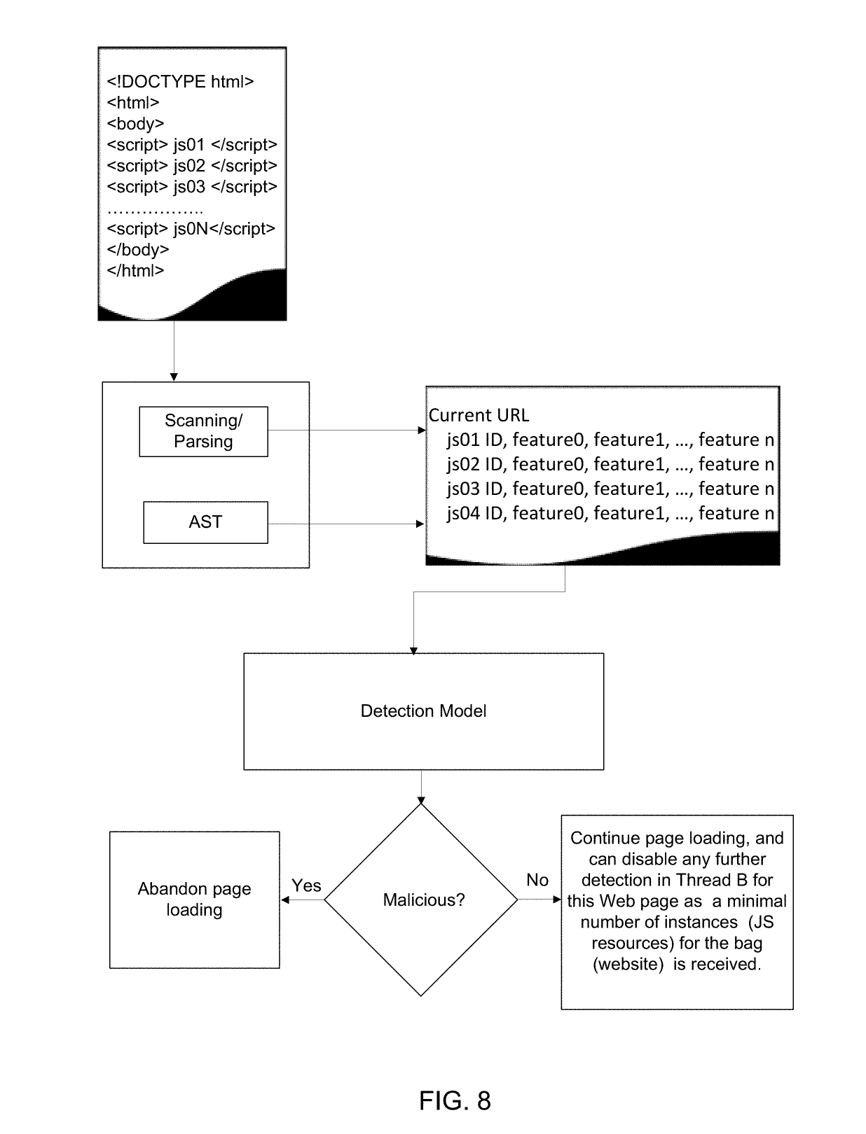

FIG. 8 depicts exemplary operation of Thread A. As shown, the speculative parser thread (Thread A) may also speculatively look ahead to request as much JavaScript resources as possible for the webpage from the web server, without impacting the normal state of the webpage loading. It may be invoked for the first time when a minimal set of JavaScript resources are received for the webpage to enable accurate detection with a low number of false alarms. As more JavaScript resources continue to arrive over the network from the website, new feature vectors are generated and the detection module 640 reapplies the detection model to them (it may include the previously gathered feature vectors also). This Thread A also has visibility into JavaScripts received over the network but not yet passed to the incremental analysis module 638.

As shown in FIG. 6, feature vectors that are generated by the speculative analysis module 636 (Thread A) may be accessed by the detection module 640 for detection. And as shown in FIG. 8, in some implementations, the detection module 640 may determine that a webpage is malicious on the basis of JavaScript feature vectors obtained only by way of the speculative parsing performed by Thread A.

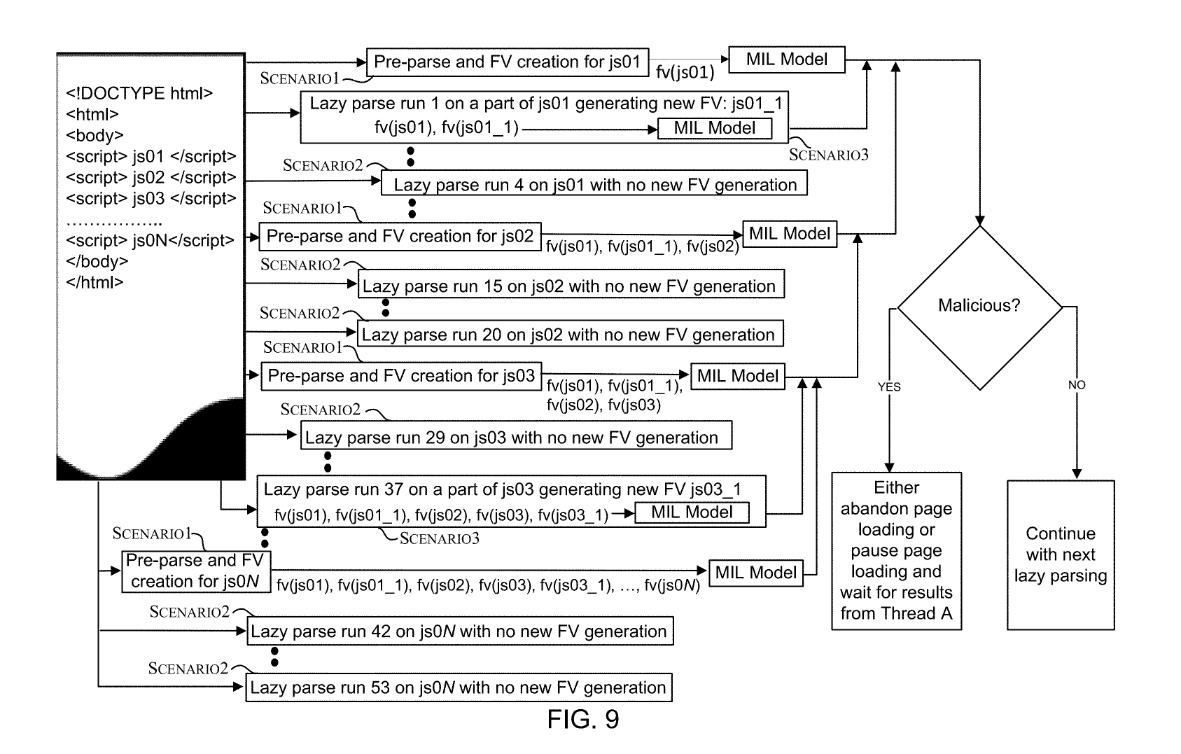

The incremental analysis module 638 may launch an incremental analysis thread (also referred to herein as Thread B). Thread B may operate as a main rendering/JavaScript thread that invokes the detection module 640 to apply the detection model as the incremental analysis module 638 encounters a new JavaScripts during lazy parsing. In this way, detection is performed in an incremental fashion with the currently available JavaScripts for the entire webpage bag. As shown in FIG. 9, this incremental analysis can work at the granularity of lazy parsing's default JavaScript processing granularity, or a parse of the full JavaScript file/snippet may be carried out when the first JavaScript block belonging to a sub-part of the file/snippet is lazily invoked by the JavaScript scanner/parser 620. Alternatively, a pre-parser can be invoked up-front on a full JavaScript file/snippet to generate feature vectors before any lazy parsing is done, which are used by the detection module 640. As shown in FIG. 6, the detection module 640 may analyze feature vectors generated by both Thread A of the speculative analysis module 636 and Thread B of the incremental analysis module 638 as the feature vectors are generated.

### Lazy-Parsing Versus Pre-Parsing in the Context of Incremental Feature Vector Generation in Thread B

In modern browsers, JavaScript code is typically lazily parsed, compiled and executed, which means that even if the entire received JavaScript resource has N functions and M lines of code, only a particular JavaScript function that needs to execute (and the associated lines of code that will execute) will be fully parsed, compiled, and then executed on demand The entire JavaScript script with N functions and M lines of code is not completely parsed and compiled in one shot. Thus, the lazy parser is called multiple times on the same JavaScript file/resource to compile different disjoint parts of it (e.g., different functions).

But in many implementations of a JavaScript engine (in the main thread) there is a very light phase called a pre-parser that runs on the entire JavaScript resource upfront to gather high level structural information JavaScript language tokens of the entire JavaScript file/resource/snippet. The pre-parser is called once upfront for a JavaScript file/resource when the JavaScript is seen for the first time and then a lazy parse gets called multiple times for different sub-parts of the JavaScript resource/file on demand. As a consequence, the number of times the lazy parse is invoked by the JavaScript scanner parser 620 for the entire webpage may be much more than the number of times the pre-parser needs to be invoked (which is same as the number of JavaScript files/resources).

Referring again to FIG. 9, shown is a depiction of how lazy parsing and pre-parsing may be carried out in connection with the incremental analysis of an exemplary webpage. In the context of the detection methods described herein, it is often beneficial to obtain the feature vectors for the entire JavaScript in one shot and as quickly as possible. So, for implementations where the JavaScript scanner/parser 620 includes a pre-parser, the pre-parser phase is utilized for feature vector creation followed by triggering the detection module 640. FIG. 9 shows an example web-page with ‘N’ JavaScript resources, and the feature-vector extractions during each of the N pre-parsing activities for the N JavaScript resources. It also shows some of the lazy parsing activities on the different JavaScript resources. FIG. 9 indicates a total of 53 lazy-parsing activities, but only a few representative one are shown for illustration and to keep the diagram simple. The lazy parsing activities that are not explicitly shown are indicated by dotted lines between the different activities in FIG. 9. Three exemplary situations that may occur in connection with incremental JavaScript analysis for a webpage are illustrated in FIG. 9:
1. Pre-parsing each newly encountered JavaScript with the generation of a feature vector (FV) for the entire JavaScript (this situation is labeled SCENARIO1 in FIG. 9).
2. Lazy parsing a portion of a JavaScript that is already pre-parsed but no new feature vector is generated during the Lazy parsing. This situation is labeled as SCENARIO2 in FIG. 9 for the Lazy parsing runs 4, 15, 20, 29, 42, 53.
3. Lazy parsing a portion of a JavaScript that is already pre-parsed and a new feature vector is generated during the Lazy parsing. This situation is labeled as SCENARIO3 in FIG. 9, which are for the Lazy parsing runs 1 and 37.

Beneficially, the pre-parsing may quickly provide a feature vector that is immediately usable by the detection module 640. For example, a feature vector produced by pre-parsing JavaScript js01 in FIG. 9 may provide sufficient information for the incremental analysis module 638 (Thread B) to pause page loading on the basis that the pre-parsing-derived feature vector for js01 indicates the webpage may be (but is not definitively) malicious. In such a case, the speculative analysis (Thread A) may continue (to obtain additional feature vectors) until the detection module 640 is able to make a definitive determination about whether the webpage is malicious or not.

Pre-parsing alone, however, may not provide sufficient details about a JavaScript to make a determination about the malicious (or benign) nature of the JavaScript. So, lazy parsing of different portions of a JavaScript may incrementally continue to add the new feature vectors for the JavaScript. As shown in FIG. 9, a feature vector fv(js01) is initially generated from pre-parsing the js01 JavaScript, and then a subsequent lazy parse (run 1) of js01 is carried out to provide a new feature vector fv(js01_1), thereby generation two feature vectors fv(js01) and fv(js01_1) for the JavaScript js01. The feature vectors fv(js02), fv(js03), . . . , fv(js0N) are the feature vectors generated during the pre-parsing step of JavaScripts js02, js03, . . . , js0N for the example web page in an incremental fashion as the page loading proceeds. Additionally during the lazy parsing run 37 of a part of JavaScript js03 a new feature vector fv(js03_1) is generated.

It should be recognized that the extent to which pre-parsing provides features values for a feature vector depends upon the particular pre-parser that is implemented in the JavaScript scanner/parser 620. In some implementations, pre-parsing may include tokenizing JavaScripts to produce tokens that may be used generate a feature vector, but lazy parsing may be necessary to generate the abstract syntax tree and symbol table for the JavaScript. It is certainly contemplated that pre-parsing capability may continue to develop to provide more details about features of pre-parsed JavaScripts; thus enabling faster generation of feature vectors, and hence, faster determinations about the malicious or benign nature of a webpage.

### Variations and Alternative Implementations

As discussed above, if the main Thread B of the incremental analysis module 638 results in detection of malicious behavior before the parallel Thread A of the speculative analysis module 636 can obtain feature vectors that confirm the findings by Thread B, then Thread B can be paused. If Thread A produces feature vectors that confirm the webpage is benign, Thread B may continue page loading. But if Thread A produces feature vectors that confirm the webpage is malicious, then webpage loading is abandoned.

The incremental analysis by Thread B can optionally be stopped after Thread A starts receiving a minimal set of JavaScript resources. Detection based upon Thread B may operate to ensure safety without delaying page loading for most cases until Thread A can take over for detection with accuracy that needs a minimal number of JavaScript resources (instances) for the webpage (bag).

In some implementations, the main Thread B may continuously do feature vector generation for detection as new JavaScript resources are seen, with intermediate help from the parallel Thread A that is limited in generating feature vectors for JavaScript resources Thread A may have analyzed and Thread B has not. Some implementations may choose to have only the incremental detection in the main Thread B, without having the speculative detection Thread A. Some implementation may choose to have only the speculative detection Thread A, without doing any incremental detection in the main Thread B.

As depicted in FIG. 6, the feature vectors generated by Thread A and Thread B may be shared in a common feature vector store 634, which may be synchronized regularly (e.g., before each detection operation by the detection module 640). In other words, the feature vectors in the feature vectors store 634 may be the result of collectively accumulating feature vectors in connection with the incremental requesting and the prefetching to produce an accumulated set of feature vectors in the feature vectors store 634. In these implementations, a determination (by the detection module 640) as to whether or not the webpage is malicious may be made when a threshold number of feature vectors are accumulated.

In other implementations, the functionality of the detection module 640 may be duplicated so that each of the speculative analysis module 636 (that spawns Thread A) and he incremental analysis module 638 (That spawns Thread B) carry out independent detection operations using feature vectors generated by the corresponding Thread.

It is also contemplated that the speculative analysis module 636 and the incremental analysis module 638 may each apply a different detection model created with different training configurations to suit the two different granularities and focus in Threads A and B.

A whitelist of uniform resource locators (URLs) of benign webpages that gave a false alarm in the past may be maintained to reduce future page loading delays for the same URL by not pausing Thread B if a malicious detection is made (because it is likely the same false alarm). This whitelist may be flushed and recreated periodically. Optionally, the detection models can be updated by re-training to ensure the false alarms are not encountered in future.

In some implementations, the parsed AST created from the speculative parsing of all loaded JavaScript resources for the webpage may be saved for later use when any of these JavaScripts need to execute (during lazy execution) to avoid duplicate parsing, thereby preventing an increase in power and performance overhead.

When malicious JavaScript code is detected, the malicious webpage detector 606 may prompt all execution of JavaScript and/or other components of the web browser for the webpage to stop, and the malicious webpage detector 606 may report a warning, or interstitial page, or close the tab, etc.

In many implementations, additional delays for most of the cases of webpage loading are prevented by allowing the main Thread B to continue to do the standard lazy parsing of JavaScripts and page loading that normally a browser does until it detects a malicious JavaScript during lazy parsing, and that is the only instance when page loading is paused. This provides safety and defensively prevents going to a bad website, while the robust (more reliable) results from Thread A are still pending. Thus, delays are avoided (hence, preventing bad user experience) for the majority of webpages where there is neither a true positive nor a false alarm at the level of individual JavaScript analysis in Thread B.

Thread B may continue page loading (when neither true positives or false alarms are seen) while Thread A completes the more robust and reliable detection by speculative parsing of all received JS resources considering them as a whole bag (web page) of instances (of JavaScripts). So, the false-alarm situation in Thread B may be the only case impacting user-experience (or delays in page loading).

For a majority of the cases where there are no false alarms due to the analysis by Thread B, a user's experience is not impacted.

### Aspects of using both Incremental Analysis (with Thread B) and Speculative Analysis (with Thread A)

Thread B may allow continued page loading in real-time by incrementally checking safety at an individual JavaScript level, but this may result in a higher number of false alarms than detection based upon the speculative analysis of Thread A. So, having Thread B alone would lead to bad user experience due to higher false alarms.

Thread A may provide the best confirmation for malicious detection, but detection analysis based upon Thread A takes more time, so having only Thread A would degrade the user experience by delaying page loading for all cases in order to obtain accuracy and very low false alarms. In some implementations, where the main detection is still based upon Thread B, Thread A may be used to gather more JavaScript resources for feature vector extraction and detection that Thread B has not seen yet. Thus, by having both Threads A and B, the benefits of an overall low number of false alarms and real time analysis (no delays) for a majority of the webpages (approximately 94% of webpages) may be achieved while only graceful delays occur when there are false alarms due to the analysis performed by Thread B (where there may be a wait to clear up the false alarms from the results from Thread A).

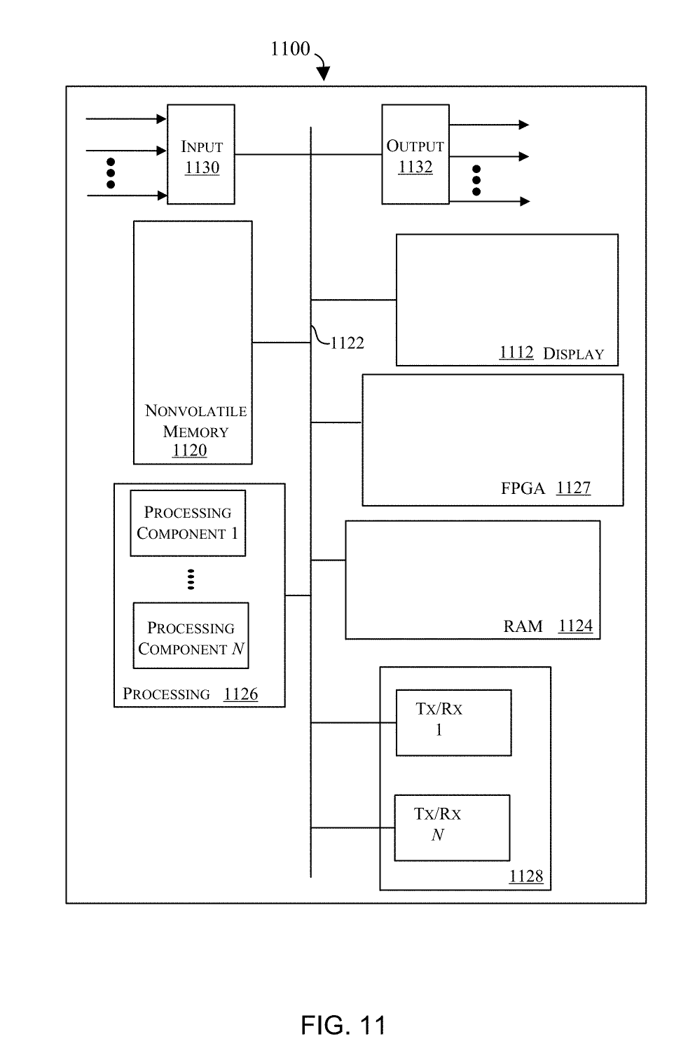

Referring FIG. 11, shown is a block diagram depicting physical components that may be utilized to realize one or more aspects of the embodiments disclosed herein. For example, aspects of the computing device 100 and offline model generator 102 may be realized by the components of FIG. 11. As shown, in this embodiment a display portion 1112 and nonvolatile memory 1120 are coupled to a bus 1122 that is also coupled to random access memory (“RAM”) 1124, a processing portion (which includes N processing components) 1126, a field programmable gate array (FPGA) 1127, and a transceiver component 1128 that includes N transceivers. Although the components depicted in FIG. 11 represent physical components, FIG. 11 is not intended to be a detailed hardware diagram; thus, many of the components depicted in FIG. 11 may be realized by common constructs or distributed among additional physical components. Moreover, it is contemplated that other existing and yet-to-be developed physical components and architectures may be utilized to implement the functional components described with reference to FIG. 11.

This display portion 1112 generally operates to provide a user interface for an operator of the computing device 100 and/or offline model generator 102. The display may be realized, for example, by a liquid crystal display or AMOLED display, and in several implementations, the display is realized by a touchscreen display to enable an operator of the computing device to request and view webpages, and view any alarms issued by the malicious webpage detector 106. In general, the nonvolatile memory 1120 is non-transitory memory that functions to store (e.g., persistently store) data and processor executable code (including executable code that is associated with effectuating the methods described herein). In some embodiments for example, the nonvolatile memory 1120 includes bootloader code, operating system code, file system code, and non-transitory processor-executable code to facilitate the execution of the functionality of the logic related to malicious webpage detection. The nonvolatile memory 1120 may also be used to realize the detection model store 110 to store the detection module.

In many implementations, the nonvolatile memory 1120 is realized by flash memory (e.g., NAND or ONE NAND memory), but it is contemplated that other memory types may also be utilized. Although it may be possible to execute the code from the nonvolatile memory 1120, the executable code in the nonvolatile memory is typically loaded into RAM 1124 and executed by one or more of the N processing components in the processing portion 1126.

The N processing components in connection with RAM 1124 generally operate to execute the instructions stored in nonvolatile memory 1120 to facilitate execution of the methods disclosed herein. For example, non-transitory processor-executable instructions to effectuate aspects of the methods described with reference to FIG. 7 and may be persistently stored in nonvolatile memory 1120 and executed by the N processing components in connection with RAM 1124. As one of ordinarily skill in the art will appreciate, the processing portion 1126 may include a video processor, digital signal processor (DSP), graphics processing unit (GPU), and other processing components.

In addition, or in the alternative, the FPGA 1127 may be configured to effectuate one or more aspects of the methodologies described herein. For example, non-transitory FPGA-configuration-instructions may be persistently stored in nonvolatile memory 1120 and accessed by the FPGA 1127 (e.g., during boot up) to configure the FPGA 1127 to effectuate one or more aspects of the methodologies and functions disclosed herein.

The depicted transceiver component 1128 includes N transceiver chains, which may be used for communicating with external devices via wireless or wireline networks. Each of the N transceiver chains may represent a transceiver associated with a particular communication scheme (e.g., WiFi, Ethernet, CDMA, LTE, Bluetooth, NFC, etc.). In operation, the transceiver component 1128 may be used to transmit requests for web content, and may be used to receive the requested web content. In addition, the transceiver component 1128 may be used to receive updates to the detection model.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for detecting malicious webpages stored in a non-volatile memory of a computing device, the method comprising:
detecting multiple JavaScripts in a webpage received at the computing device, wherein each of the JavaScripts can be separately executed;
generating a feature vector for each of the JavaScripts to produce a plurality of feature vectors for the webpage, wherein a particular feature vector includes values for different features of a particular JavaScript; and
analyzing each of the feature vectors with a detection model stored on the computing device to determine whether the webpage from which the JavaScripts originate is malicious or benign, the detection model is a multi-instance-based detection model for analyzing multiple JavaScript instances of a webpage-level-bag.

2. The method of claim 1, including:
tokenizing each of the JavaScripts to produce tokens;
creating an abstract syntax tree for each of the JavaScripts;
creating a symbol table for each of the JavaScripts;
recording functional activities in the web browser; and
generating the feature vector for each JavaScript from the tokens, from nodes and edges of the abstract syntax tree, from the symbol table, and from functional activities recorded in the web browser.

3. The method of claim 1, including:
determining whether the webpage is malicious based upon a number of malicious JavaScripts in the webpage relative to a number of benign JavaScripts in the webpage.

4. The method of claim 1, including:
incrementally requesting JavaScripts as needed to render the webpage and analyzing the incrementally requested JavaScripts to generate feature vectors as the JavaScripts are incrementally received; and
prefetching JavaScripts of the webpage, before the JavaScripts are needed to render the webpage, to generate feature vectors.

5. The method of claim 4, including:
pausing a loading of the webpage if feature vectors of the incrementally requested JavaScripts are suspect feature vectors;
continuing to prefetch JavaScripts to confirm whether or not the webpage is malicious;
resuming the loading of the webpage if the prefetched JavaScripts indicate the webpage is benign; and
abandoning the loading of the webpage if the prefetched JavaScripts indicate the webpage is malicious.

6. The method of claim 4, including:
abandoning a loading of the webpage if feature vectors of the incrementally requested JavaScripts indicate the webpage is malicious.

7. The method of claim 4, including:
collectively accumulating feature vectors in connection with the incremental requesting and the prefetching to produce an accumulated set of feature vectors; and
determining whether or not the webpage is malicious when a threshold number of feature vectors are accumulated.

8. The method of claim 7, wherein generating the plurality of JavaScript feature vectors includes pre-parsing each of the JavaScripts when each of the JavaScripts encountered for a first time.

9. An apparatus for analyzing and displaying web content, the apparatus comprising:
one or more transceivers for transmitting requests for web content and receiving the web content;
a model manager configured maintain a detection model in a non-volatile memory of the computing device;
a webpage processing portion configured to generate requests for the web content, receive the web content, and detect multiple JavaScripts in a webpage, wherein each of the JavaScripts can be separately executed;
a malicious webpage detector including:
an incremental analysis module configured to incrementally request JavaScripts to render the webpage and analyze the incrementally requested JavaScripts to generate feature vectors as the JavaScripts are incrementally requested;
a speculative analysis module configured to prefetch JavaScripts, before the JavaScripts are needed to render the webpage, to generate feature vectors; and
a detection module to apply the detection model to the feature vectors to determine whether or not the webpage is malicious.

10. The apparatus of claim 9, wherein the detection module is a multi-instance learning based detection model.

11. The apparatus of claim 9, wherein the detection module determines whether or not the webpage is malicious based upon a number of malicious JavaScripts in the webpage relative to a number of benign JavaScripts in the webpage.

12. The apparatus of claim 9, wherein the malicious webpage detector is integrated within a browser.

13. The apparatus of claim 9, wherein the speculative analysis module and the incremental analysis module collectively accumulate feature vectors in connection with the incremental requesting and the prefetching to produce an accumulated set of feature vectors.

14. The apparatus of claim 9, wherein the speculative analysis module and the incremental analysis module are configured to generate the feature vector for each of the JavaScript instances by generating a plurality of JavaScript feature values for each feature vector.

15. The apparatus of claim 14 including a JavaScript pre-parser to generate the plurality of JavaScript features for an entire JavaScript when the JavaScript is encountered for the first time.

16. An apparatus for analyzing and displaying web content, the apparatus comprising:
one or more transceivers for requesting and receiving web content and receiving updates to a detection model for detecting malicious JavaScripts;
at least one processor;
non-volatile memory for storing the detection model and non-transitory processor executable code, the non-transitory processor executable code including instructions for:
incrementally requesting JavaScripts to render a webpage and analyzing the incrementally requested JavaScripts to generate feature vectors as the JavaScripts are incrementally requested; and
prefetching JavaScripts of the webpage, before the JavaScripts are needed to render the webpage, to generate feature vectors independently from the incrementally requested JavaScripts; and
analyzing the feature vectors with the detection model to to determine whether or not the webpage includes malicious JavaScripts.

17. The apparatus of claim 16, wherein determining whether or not the webpage is malicious includes determining whether or not the webpage is malicious based upon a number of malicious JavaScripts in the webpage relative to a number of benign JavaScripts in the webpage.

18. The apparatus of claim 16, wherein the non-transitory processor executable code includes instructions for:
collectively accumulating feature vectors in connection with the incremental requesting and the prefetching to produce an accumulated set of feature vectors; and
determining whether or not the webpage is malicious when a threshold number of feature vectors are accumulated.

19. The apparatus of claim 16, wherein the instructions include instructions for pre-parsing each JavaScript instance to generate the plurality of JavaScript features.
